(19) United States
(12) Patent Application Publication
(10) Pub. No.: US 2023/0208956 A1
(43) Pub. Date: Jun. 29, 2023

(54) MOBILE PHONE CAMERA MODULE

(71) Applicant: AAC Optics (Nanning) Co., Ltd., Nanning City (CN)

(72) Inventors: Yuancheng Lu, Shenzhen (CN); Wen Guo, Shenzhen (CN)

(21) Appl. No.: 17/837,011

(22) Filed: Jun. 9, 2022

(30) Foreign Application Priority Data
Dec. 29, 2021 (CN) 202123383267.8

(51) Int. Cl. H04M 1/02; H04N 5/225

(52) U.S. Cl. CPC H04M 1/0264; H04N 5/2252

(57) ABSTRACT

The present disclosure provides a mobile phone camera module, and relates to the field of cameras. The mobile phone camera module includes a bracket assembly having an accommodation cavity, a flexible circuit board fixed to a first side of the bracket assembly, a chip accommodated in the accommodation cavity and electrically connected to the flexible circuit board, a lens assembly disposed on a second side of the bracket assembly and disposed opposite to the flexible circuit board, and a connecting portion connecting the lens assembly to the second side of the bracket assembly. The connecting portion is disposed between the bracket assembly and the lens assembly. The present disclosure solves the problem that the particles drop directly on the surface of the chip during focusing assembly, thereby affecting the image quality.

### TECHNICAL FIELD

The present disclosure relates to the field of cameras, in particular to a mobile phone camera module.

### BACKGROUND

The number of mobile phone cameras on the market is increasing, but a size of a head of a mobile phone camera is decreasing. Therefore, a proportion of the head of the mobile phone camera on the mobile phone is decreasing, and there is less space given to the camera on the mobile phone, so the space of a single body of the camera on the mobile phone become smaller. A focusing mobile phone camera with a fixed focal length is mainly used as a front-facing camera and a rear-facing auxiliary camera of the mobile phone, which is mainly composed of a lens assembly, a bracket assembly, a connector, a flexible printed circuit (FPC) board, a chip, etc. A size of a head of the focusing mobile phone camera with the fixed focal length is determined by the lens assembly and the bracket assembly.

The existing camera with a fixed focal length is a threaded focusing camera, and focusing assembly is performed through external threads on the lens assembly and internal threads on the bracket assembly. Particles generated by the threaded focusing camera during the focusing assembly may drop directly on a surface of the chip, thus affecting the image quality.

Therefore, a mobile phone camera module is desired.

### SUMMARY

The present disclosure aims to provide a mobile phone camera module to solve a problem that particles drop directly on a surface of the chip during focusing assembly, thereby affecting the image quality.

The technical solution of the present disclosure is as follows. A mobile phone camera module is provided, including a bracket assembly having an accommodation cavity, a flexible circuit board fixed to a first side of the bracket assembly, a chip accommodated in the accommodation cavity and electrically connected to the flexible circuit board, a lens assembly disposed on a second side of the bracket assembly and disposed opposite to the flexible circuit board, and a connecting portion connecting the lens assembly to the second side of the bracket assembly; the connecting portion being disposed between the bracket assembly and the lens assembly.

As an improvement, an outer diameter of the bracket assembly is the same as an outer diameter of the lens assembly.

As an improvement, the connecting portion has a continuous annular structure.

As an improvement, an outer diameter of the connecting portion is the same as an outer diameter of the bracket assembly.

As an improvement, the connecting portion is an adhesive layer.

As an improvement, the adhesive layer is made of AA glue.

As an improvement, a size of the accommodation cavity matches a size of the chip.

As an improvement, the mobile phone camera module further includes a capacitor-resistor assembly, wherein the flexible circuit board includes a bending area disposed in correspondence with the bracket assembly and a non-bending area connected to the bending area, and the capacitor-resistor assembly is fixed on the non-bending area.

As an improvement, the mobile phone camera module further includes an insulating adhesive layer coated on the flexible circuit board and the capacitor-resistor assembly.

As an improvement, an outer diameter of the lens assembly is 5.2 mm.

The present disclosure has the following beneficial effects.

The mobile phone camera module in the present disclosure includes a bracket assembly, a lens assembly, a flexible circuit board, a chip and a connecting portion. The connecting portion is able to separate the lens assembly and the bracket assembly, and connect the bracket assembly and the lens assembly together, thereby improving the stability of the module during imaging, and preventing particles generated during focusing from falling directly on the surface of the chip.

It should be understood that the above general description and the following detailed description are merely exemplary and do not limit the present disclosure.

### BRIEF DESCRIPTION OF DRAWINGS

FIG. 1 is a schematic structural diagram of a mobile phone camera module according to the present disclosure.

FIG. 2 is a schematic structural diagram of FIG. 1 in a main view direction.

FIG. 3 is a full structure schematic diagram along line A-A of FIG. 2.

### DETAILED DESCRIPTION OF EMBODIMENTS

The following describes the present disclosure further with reference to the accompanying drawings and embodiments.

All other embodiments obtained by those of ordinary skill in the art without creative effort, based on the embodiments of the present disclosure, fall within the scope of the present disclosure.

The terms ‘first,’ ‘second,’ and ‘third’ in the present disclosure are used for descriptive purposes only and are not to be understood to indicate or imply relative importance or to imply the number of indicated technical features. Thus, a feature that is defined as ‘first,’ ‘second,’ or ‘third’ may include, explicitly or implicitly, at least one of the features. In the description of the present disclosure, ‘a plurality of’ means at least two, such as two, three, etc., unless otherwise expressly specified. All directivity indications, such as top, bottom, left, right, front, and rear . . . , in embodiments of the present disclosure are used only to explain relative positional relationship between components, movements of the components, etc., under a particular attitude (such as shown in the accompanying drawings), and the directivity indication changes accordingly if the particular attitude changes. Furthermore, the terms ‘include’ and ‘have’ and any variations thereof are intended to cover non-exclusive inclusions. For example, a process, method, system, product, or device that includes a series of steps or units is not limited to the listed steps or units, but optionally further includes the steps or units not listed, or optionally further includes steps or units inherent to the process, method, product, or device.

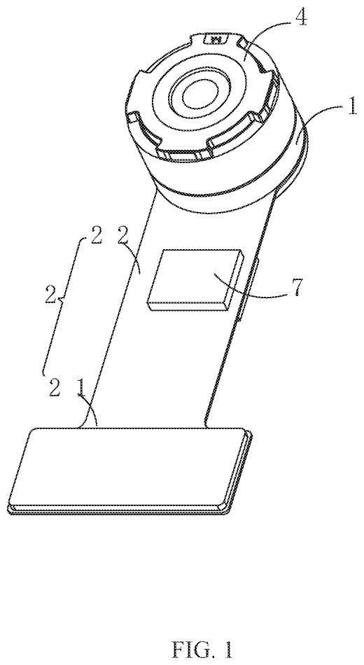

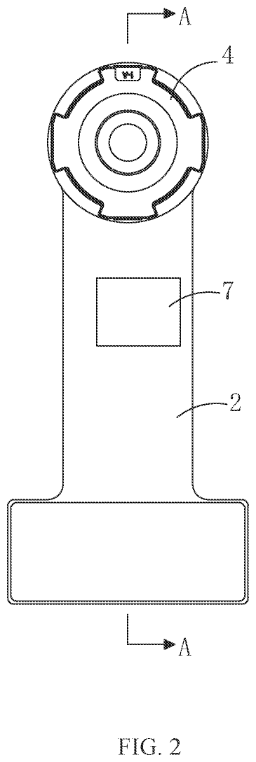

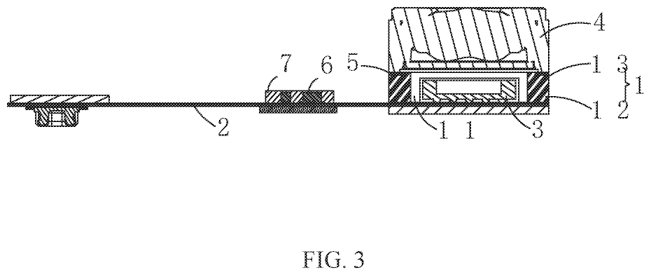

As shown in FIGS. 1 to 3, the present disclosure provides a mobile phone camera module, which includes a bracket assembly 1 having an accommodation cavity 11, a flexible circuit board 2 fixed to a first side 12 of the bracket assembly 1, a chip 3 accommodated in the accommodation cavity 11 and electrically connected to the flexible circuit board 2, a lens assembly 4 disposed on a second side 13 of the bracket assembly 1 and disposed opposite to the flexible circuit board 2, and a connecting portion 5 connecting the lens assembly 4 to the second side 13 of the bracket assembly 1. The connecting portion 5 is disposed between the bracket assembly 1 and the lens assembly 4.

During assembling of the mobile phone camera module, the bracket assembly 1 and the lens assembly 4 are fixed together only through the connecting portion 5 without being connected through a threaded structure, thereby not only being less likely to generate particles, but also avoiding the particles falling directly on the surface of the chip 3 during focusing.

As an improvement, an outer diameter of the bracket assembly 1 is the same as an outer diameter of the lens assembly 4. When the outer diameter of the bracket assembly 1 is the same as the outer diameter of the lens assembly 4, it is convenient to fix the bracket assembly 1 and the lens assembly 4 together, so that the assembling is more convenient. Meanwhile, a shape of the bracket assembly 1 is changed from an original square shape to a cylindrical shape similar to the lens assembly 4, so that it is more convenient to fix the bracket assembly 1 and the lens assembly 4 together.

As an improvement, the connecting portion 5 has a continuous annular structure. The connecting portion 5 of the annular structure makes it more convenient to fix the bracket assembly 1 and the lens assembly 4 together.

As an improvement, an outer diameter of the connecting portion 5 is the same as an outer diameter of the bracket assembly 1. In this way, it is more convenient to fix the bracket assembly 1 and the lens assembly 4, and the structure is more beautiful and compact.

As an improvement, the connecting portion 5 is an adhesive layer. It should be noted that the connecting portion 5 in the present disclosure may be another type of structure capable of fixing the bracket assembly 1 and the lens assembly 4 together. For example, the connecting portion 5 may be a latching block and latching slot structure (i.e., the latching block is disposed on the bracket assembly 1, and the latching slot is correspondingly disposed on the lens assembly 4), or may be a screw or a bolt (i.e., the bracket assembly 1 and the lens assembly 4 are fixed together by the screw or the bolt). In the present disclosure, the connecting portion 5 is disposed as the adhesive layer because it is relatively cheap and convenient to fix the bracket assembly 1 and the lens assembly 4 together by using the adhesive layer as the connection portion 5.

As an improvement, the adhesive layer is made of AA glue. It should be noted that the adhesive layer in the present disclosure may be made of other glue, for example, the adhesive layer in the present disclosure is made of AB glue, silicone sealant, etc. The adhesive layer in the present disclosure is made of AA glue because the AA glue not only makes the imaging stability of the module better, has an appropriate cost, and effectively avoids the particles from falling directly on the surface of the chip 3 during focusing, but also keeps an optical design of the mobile phone camera module unchanged and reduces the outer diameter of the module.

As an improvement, a size of the accommodation cavity 11 matches a size of the chip 3. In this way, the structure of the mobile phone camera module is more compact and stability of the structure is higher.

As an improvement, the mobile phone camera module further includes a capacitor-resistor assembly 6. The flexible circuit board 2 includes a bending area 21 disposed in correspondence with the bracket assembly 1 and a non-bending area 22 connected to the bending area 21, and the capacitor-resistor assembly 6 is fixed on the non-bending area 22.

It should be noted that the capacitor-resistor assembly 6 includes electronic components such as resistors and capacitors. The capacitor-resistor assembly 6 in the present disclosure is able to be moved to the flexible circuit board 2 (such as an FPC board), so that the structure of the bracket assembly 1 is more compact, and the structure stability of the mobile phone camera module is further improved. Meanwhile, in the present disclosure, by appropriately extending the flexible circuit board 2 and avoiding the bending area 21 of the flexible circuit board 2 from the capacitor-resistor assembly 6, the signal transmission effect of the mobile phone camera module is better, and thus the imaging effect of the mobile phone camera module is better.

As an improvement, the mobile phone camera module further includes an insulating adhesive layer 7 coated on the flexible circuit board 2 and the capacitor-resistor assembly 6. The insulating adhesive layer 7 is able to form plastic encapsulation protection for the flexible circuit board 2 and the capacitor-resistor assembly 6, so that the structure stability of the mobile phone camera module is better.

As an improvement, an outer diameter of the lens assembly 4 is 5.2 mm. In this way, the outer diameter of the mobile phone camera module in the present disclosure is also relatively small, so that the outer diameter of the module is reduced from 6.5 mm to 5.2 mm.

The above description merely involves embodiments of the mobile phone camera module in the present disclosure, and it should be noted that, for those of ordinary skills in the art, improvements may be made without departing from the inventive concept of the present disclosure, which also belong to the protection scope of the present disclosure.

What is claimed is:

1. A mobile phone camera module, comprising: a bracket assembly having an accommodation cavity, a flexible circuit board fixed to a first side of the bracket assembly, a chip accommodated in the accommodation cavity and electrically connected to the flexible circuit board, a lens assembly disposed on a second side of the bracket assembly and disposed opposite to the flexible circuit board, and a connecting portion connecting the lens assembly to the second side of the bracket assembly; the connecting portion being disposed between the bracket assembly and the lens assembly.

2. The mobile phone camera module according to claim 1, wherein an outer diameter of the bracket assembly is the same as an outer diameter of the lens assembly.

3. The mobile phone camera module according to claim 2, wherein the connecting portion has a continuous annular structure.

4. The mobile phone camera module according to claim 3, wherein an outer diameter of the connecting portion is the same as an outer diameter of the bracket assembly.

5. The mobile phone camera module according to claim 1, wherein the connecting portion is an adhesive layer.

6. The mobile phone camera module according to claim 5, wherein the adhesive layer is made of AA glue.

7. The mobile phone camera module according to claim 1, wherein a size of the accommodation cavity matches a size of the chip.

8. The mobile phone camera module according to claim 1, further comprising a capacitor-resistor assembly, wherein the flexible circuit board comprises a bending area disposed in correspondence with the bracket assembly and a non-bending area connected to the bending area, and the capacitor-resistor assembly is fixed on the non-bending area.

9. The mobile phone camera module according to claim 7, further comprising a capacitor-resistor assembly, wherein the flexible circuit board comprises a bending area disposed in correspondence with the bracket assembly and a non-bending area connected to the bending area, and the capacitor-resistor assembly is fixed on the non-bending area.

10. The mobile phone camera module according to claim 8, further comprising an insulating adhesive layer coated on the flexible circuit board and the capacitor-resistor assembly.

11. The mobile phone camera module according to claim 1, wherein an outer diameter of the lens assembly is 5.2 mm.

12. The mobile phone camera module according to claim 2, wherein an outer diameter of the lens assembly is 5.2 mm.

13. The mobile phone camera module according to claim 3, wherein an outer diameter of the lens assembly is 5.2 mm.

14. The mobile phone camera module according to claim 4, wherein an outer diameter of the lens assembly is 5.2 mm.

15. The mobile phone camera module according to claim 5, wherein an outer diameter of the lens assembly is 5.2 mm.

16. The mobile phone camera module according to claim 6, wherein an outer diameter of the lens assembly is 5.2 mm.

17. The mobile phone camera module according to claim 7, wherein an outer diameter of the lens assembly is 5.2 mm.
